(19) United States
(12) Patent Application Publication
(10) Pub. No.: US 2011/0076631 A1
(43) Pub. Date: Mar. 31, 2011

(54) Self-extinguishing candlewick

(76) Inventor: Robert Peter Wodraska, Panama City, FL (US)

(21) Appl. No.: 12/586,641

(22) Filed: Sep. 25, 2009

(51) Int. Cl. F23D 3/16; C11C 5/00

(52) U.S. Cl. 431/289

(57) ABSTRACT

A candlewick includes a plurality of flame-extinguishing sleeves disposed thereon that are configured with a length and spacing that cause the candlewick to self-extinguish after a pre-determined time interval. Each flame-extinguishing sleeve is comprised of a non-combustible material that prevents consumption of the candlewick contained therein, and is configured to conduct heat into the body of the candle when a flame is disposed at the top of said sleeve. The wall thickness and the material making up the non-combustible sleeves are selected to provide sufficient heat transfer into the body of the candle to melt the candle base material, that is in contact with the flame-extinguishing sleeve when a candle flame reaches the top edge of said sleeve.

### BACKGROUND OF THE INVENTION

1. Field of the Invention

Embodiments of the present invention relate generally to candles and, more particularly, to a self-extinguishing wick for such candles.

2. Description of the Related Art

Wax-based candles are commonly used for specialized illumination, such as emergency lighting or to contribute to ambience. In addition, candles are used to provide a desirable scent. For any of these applications, an individual candle is typically sized to provide illumination and/or scent for a large number of uses. For example, candles are often sized to have a burn time of dozens of hours or more, but may only be used for a few hours at one time. However, candles commonly known in the art typically are not designed to self-extinguish and, therefore, will continue to burn until completely exhausted unless extinguished by the user. This can make the use of candles inconvenient and, in some cases, a safety hazard. In fact, according to Candle Fires in Residential Structures, a report by U.S. Department of Homeland Security, candles are responsible for an estimated 23,600 residential structure fires each year and cause 1,525 civilian injuries, 165 fatalities, and $390 million in direct property loss.

Accordingly, there is a need in the art for a candle designed to burn for a specified period of time, self-extinguish, and be ready for relighting when next required by the user.

### SUMMARY OF THE INVENTION

One or more embodiments of the invention provide a self-extinguishing candlewick. The embodiments employ a plurality of flame-extinguishing sleeves positioned on the candlewick. Each flame-extinguishing sleeve is configured to conduct enough heat from a flame disposed at the top of the flame-extinguishing sleeve to form a wax pool that contacts the bottom edge of the flame-extinguishing sleeve.

One advantage of the disclosed invention is that a candle can be used for a predetermined interval and will self-extinguish at the end of said time interval. Another advantage of the disclosed invention is that modification of a conventional wick to incorporate the disclosed invention is relatively simple to implement.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic cross-sectional view of a typical candle 100 known in the art.

FIGS. 2A-2D are schematic cross-sectional views of a self-extinguishing candle 200 during use, according to embodiments of the invention.

For clarity, identical reference numbers have been used, where applicable, to designate identical elements that are common between figures. It is contemplated that features of one embodiment may be incorporated in other embodiments without further recitation.

### DETAILED DESCRIPTION

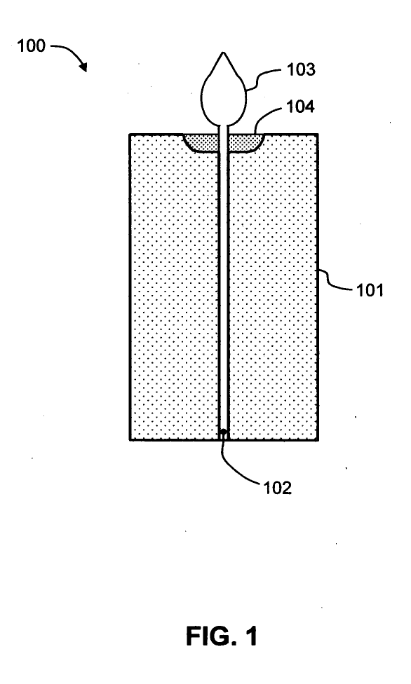

FIG. 1 is a schematic cross-sectional view of a typical candle 100 known in the art. Candle 100 includes a body 101 and a wick 102. Body 101 is a solid candle base material, such as paraffin-containing wax, that serves as fuel for candle 100 when lit. Wick 102 is a liquid-wax-absorbing material known in the art, such as a braided fiber wick. When candle 100 is in use, wick 102 is lit, producing a flame 103 as shown. Heat produced by flame 103 melts the solid candle base material proximate wick 102, creating a pool 104 of liquid fuel. In its liquid state, the liquid fuel in pool 104 is carried to flame 103 by capillary action within wick 102. As candle 100 burns and body 101 is consumed, the position of flame 103 advances downward along wick 102 until no liquid fuel is available or wick 102 is consumed. Consequently, candle 100 will continue to burn until completely consumed unless candle 100 is actively extinguished by a user.

Embodiments of the invention contemplate a candlewick with a plurality of flame-extinguishing sleeves disposed thereon that are configured with a length and spacing that cause the candlewick to self-extinguish after a pre-determined time interval. Each flame-extinguishing sleeve is comprised of a non-combustible material that prevents consumption of the candlewick contained therein, and is configured to conduct heat into the body of the candle when a flame is disposed at the top of said sleeve. The wall thickness and the material making up the non-combustible sleeves are selected to provide sufficient heat transfer into the body of the candle to melt the candle base material, e.g., wax, that is in contact with the flame-extinguishing sleeve when a candle flame reaches the top edge of said sleeve. Because of the heat transfer capability of the flame-extinguishing sleeves, a pool of molten candle base material is formed around said sleeve and fuels the candle flame by being drawn up through the wick. As the candle flame continues to burn, the pool of molten candle base material surrounding the flame-extinguishing sleeve is drained and the candle flame burns out. The flame-extinguishing sleeve may then be removed and the candle relit.

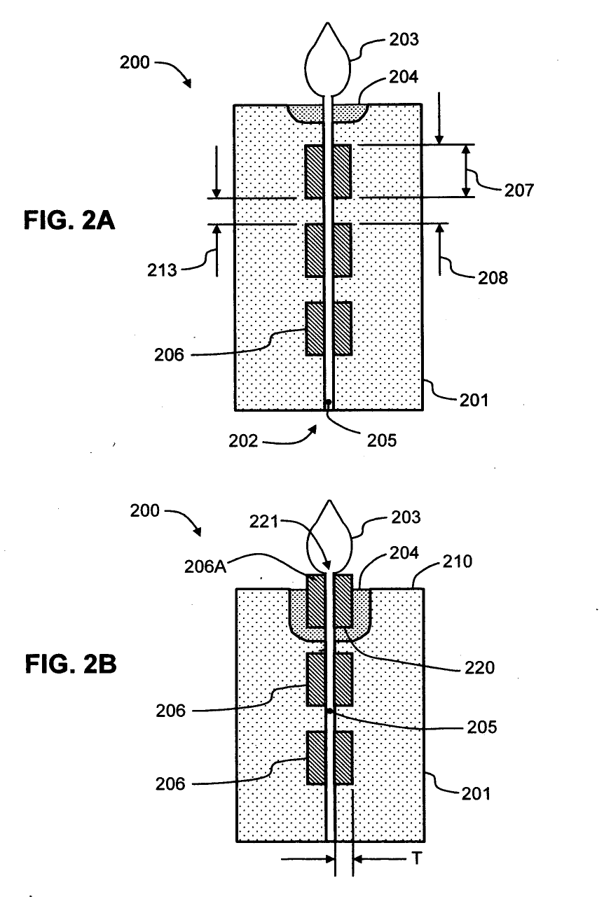

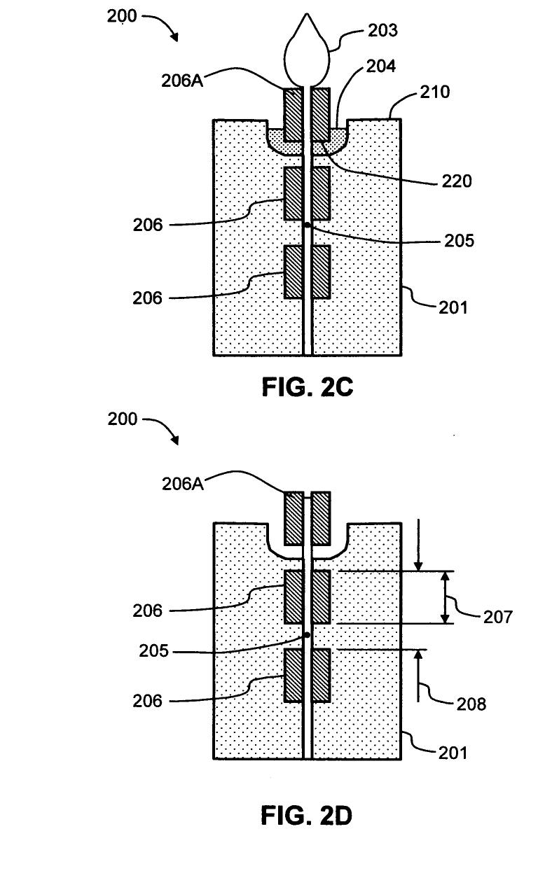

FIGS. 2A-2D are schematic cross-sectional views of a self-extinguishing candle 200 during use, according to an embodiment of the invention. FIG. 2A illustrates self-extinguishing candle 200 burning normally. Self-extinguishing candle 200 includes a candle body 201 and a self-extinguishing wick 202. As shown, during use a flame 203 is disposed on the end of self-extinguishing wick 202, and is fueled by molten candle body material that is drawn by capillary action through self-extinguishing wick 202 from a wax pool 204 of molten candle body material. Heat from flame 203 melts the candle body material located near flame 203 to form wax pool 204.

Candle body 201 includes any solid candle base material known in the art, such as paraffin-containing wax, that serves as fuel for candle 200 when lit. The term “candle base material” refers to any material that can be used to form a candle. A suitable candle base material may be solid or semi-solid at room temperature, which, upon melting due to exposure to flame 203, provides a liquid fuel source to self-extinguishing wick 202. One common form of candle base material is wax, which usually refers to a substance that is plastic to brittle solid at room temperature and becomes a low viscosity liquid when heated by flame 203. Suitable waxes for forming candle body 201 include any known waxes, including, paraffin wax, microcrystalline wax, beeswax, animal wax, vegetable wax, mineral wax, synthetic wax, and mixtures thereof. In addition to wax, semi-solids (such as petrolatum), synthetic polymers and mixtures of synthetic polymers with one or more organic compounds may be included in the solid candle base material contained in candle body 201. Other candle fuel source components, such as hydrocarbon oil, stearic acid, etc., may be also included in the candle base material.

Self-extinguishing wick 202 includes a wicking element 205, which is made up of an elongated, liquid-wax-absorbing material, such as a conventional braided fiber wick known in the art. The performance-related characteristics of wicking element 205, such as wick size, wick density, and fiber material, depend on a number of factors, including the type of solid candle base material contained in candle body 201, the diameter or width of candle body 201, the desired burn rate and flame height of the candle, etc., and may be selected using methods commonly known in the art. In addition to wicking element 205, self-extinguishing wick 202 includes a plurality of non-combustible sleeves 206 positioned on wicking element 205, as shown. Non-combustible sleeves 206 are separated by a gap 213. In one embodiment, gap 213 is no less than about ⅛ inches, to ensure the flow of molten candle base material to flame 203. The composition of non-combustible sleeves 206 is described below in conjunction with FIG. 2B. The length 207 and spacing 208 of non-combustible sleeves 206 are selected so that flame 203 is extinguished a pre-determined time interval after self-extinguishing candle 200 is lit. For example, length 207 and spacing 208 may be selected so that self-extinguishing candle 200 will burn for 3 hours after being lit and then self-extinguish. The self-extinguishing mechanism of self-extinguishing wick 202 is also described in greater detail below.

FIG. 2B illustrates self-extinguishing candle 200 after a portion of candle body 201 has been consumed and an exposed non-combustible sleeve 206A projects above top surface 210 of candle body 201. Non-combustible sleeves 206 are comprised of a material that is non-flammable at the temperatures present in a candle flame, and prevent the portion of wicking element 205 contained therein from being consumed by flame 203. Consequently, flame 203 remains at the top of exposed non-combustible sleeve 206A, as shown, and molten candle body material is drawn to flame 203 through the length of wicking element 205 that is disposed inside exposed non-combustible sleeve 206A.

In addition to protecting wicking element 205 from being consumed by flame 203, non-combustible sleeves 206 are also configured to conduct heat from flame 203 to candle body 201, so that wax pool 204 continues to provide fuel to flame 203 even as flame 203 is displaced further from surface 210. Therefore, each of non-combustible sleeves 206 is configured to transfer sufficient heat from flame 203 to surrounding candle body 201 so that wax pool 204 wets wicking element 205 at the point that wicking element 205 enters bottom opening 220 of exposed non-combustible sleeve 206A. In addition, each of non-combustible sleeves 206 is configured with an inner conduit 221 sized so that wicking element 205 can wick molten candle base material from wax pool 204 at bottom opening 220 to flame 203, i.e., inner conduit 221 is large enough to allow the wicking action of wicking element 205 to keep flame 203 burning. Thus, because of the size of inner conduit 221 and the heat transfer of non-combustible sleeves 206 to surrounding candle body 201, molten candle body material can continue to be drawn to flame 203 through wicking element 205 when flame 203 is disposed on exposed non-combustible sleeve 206A. If such were not the case, liquid fuel will not be available for combustion and flame 203 will extinguish once it is in contact with exposed non-combustible sleeve 206A, leaving exposed non-combustible sleeve 206A almost completely enclosed by candle body 201 and very difficult to remove for subsequent lighting of self-extinguishing candle 200. Consequently, the heat-conducting capability of non-combustible sleeves 206 is considered in embodiments of the invention. To that end, non-combustible sleeves 206 may be comprised of a heat-conducting material and configured with a wall thickness T that enables sufficient heat conducting capability to form wax pool 204 at bottom opening 220, as shown.

To ensure that wax pool 204 is formed around exposed non-combustible sleeve 206A as shown in FIG. 2B, both the wall thickness T and the thermal conductivity of the material making up non-combustible sleeves 206 may be considered. In one embodiment, non-combustible sleeves 206 are comprised of a non-combustible metal, such as copper or aluminum, having a higher thermal conductivity than many other non-combustible materials, such as glass or ceramics. Other metals may also be used, such as steel. In one embodiment, wall thickness T is configured to further increase heat transfer by non-combustible sleeves 206 from flame 203. Namely, wall thickness T may be selected to be thicker than required to simply act as a non-combustible appliance that encloses wicking element 205. For example, for a paraffin-wax candle with a standard pre-waxed wicking element 205 having a diameter of approximately 0.08 inches to 0.09 inches, non-combustible sleeves 206 may be comprised of copper and have a wall thickness of at least 0.01 inches to conduct enough heat from flame 203 to form wax pool 204. One of skill in the art, upon reading the disclosure herein, may readily devise a non-combustible sleeve 206 for a candle having a different candle base material and/or a different size wicking element 205 than that described herein.

FIG. 2C illustrates self-extinguishing candle 200 after enough of candle body 201 has been consumed that flame 203 is too far from candle body 201 to melt more of the candle base material making up candle body 201. Consequently, wax pool 204 is no longer replenished with molten candle base material from candle body 201 and is depleted as shown. Because wicking element 205 is still wetted by wax pool 204 at bottom opening 220, flame 203 continues to burn. FIG. 2D illustrates self-extinguishing candle 200 after wax pool 204 has been consumed and molten candle base material can no longer be provided to flame 203. As shown, exposed non-combustible sleeve 206A projects above candle body 201 and can easily be removed by the user to reveal an exposed length of wicking element 205 that can be lit for subsequent use of self-extinguishing candle 200. When enough of candle body 201 is consumed so that a non-combustible sleeve 206 is again exposed above candle body 201 and wax pool 204 is again consumed, self-extinguishing candle 200 will again self-extinguish. The user may repeat this process until candle body 201 is substantially consumed.

As noted above, the predetermined burn time of self-extinguishing candle 200 depends on a number of factors, including length 207 and spacing 208 of non-combustible sleeves 206, as well as on the diameter of self-extinguishing candle 200, the burn rate of wicking element 205, and the candle base material. In one embodiment, self-extinguishing candle 200 is a paraffin-wax candle having a diameter of approximately 3 inches and a pre-waxed wicking element 205 with a diameter of 0.085 inches, and is configured to burn in approximately 2-hour intervals before self-extinguishing. In such an embodiment, non-combustible sleeves 206 are comprised of copper, gap 213 is approximately 3/16 inches, wall thickness T is approximately 0.01 to 0.02 inches, length 207 is approximately ⅜ inches and spacing 208 is approximately 9/16 inches. One of skill in the art, upon reading the disclosure herein, can readily determine the spacing 208 and length 207 of non-combustible sleeves 206 for other configurations of self-extinguishing candle 200 than that described herein.

In order for even burn internals for self-extinguishing candle 200, the positioning of non-combustible sleeves 206 on wicking element 205 should be robust and relatively precise, for example within ± 1/32 inches. In one embodiment, non-combustible sleeves 206 are precisely held in place on wicking element 205 by crimping one end of the sleeve onto wicking element 205. In this way non-combustible sleeves 206 are firmly attached to wicking element 205 and will not slide downward as the wax of wicking element 205 is melted by flame 203. In one embodiment, non-combustible sleeves 206 are crimped at the top edge to facilitate removal from wicking element 205 after self-extinguishing candle 200 has self-extinguished. In another embodiment, other means are used to precisely position and hold in place non-combustible sleeves 206. For example, wicking element 205 may be knotted or include other means for holding non-combustible sleeves 206 in place as desired.

In one embodiment, non-combustible sleeves 206 are substantially cylindrical in shape. However, other configurations of non-combustible sleeves 206 are also contemplated by embodiment of the invention.

While the foregoing is directed to embodiments of the present invention, other and further embodiments of the invention may be devised without departing from the basic scope thereof, and the scope thereof is determined by the claims that follow.

I claim:

1. A self-extinguishing candle, comprising:
a body comprised of a candle base material;
a single wicking element disposed inside the body; and
a first non-combustible sleeve that has a top opening and a bottom opening and is disposed on the wicking element so that the wicking element passes through the top opening and the bottom opening,
wherein the first non-combustible sleeve is configured to conduct heat from a flame disposed at the top opening to form a pool of molten candle base material that wets the wicking element at the bottom opening.

2. The self-extinguishing candle of claim 1, further comprising a second non-combustible sleeve that has a top opening and a bottom opening and is disposed on the wicking element so that the wicking element passes through the top and bottom openings of the second non-combustible sleeve,
wherein the second non-combustible sleeve is disposed on the wicking element below the first non-combustible sleeve and is separated from the first non-combustible sleeve by a gap.

3. The self-extinguishing candle of claim 2, wherein the distance between the top opening of the first non-combustible sleeve and the top opening of the second non-combustible sleeve is configured so that the self-extinguishing candle will burn for a pre-determined time interval and then self-extinguish.

4. The self-extinguishing candle of claim 1, wherein the first non-combustible sleeve has a sleeve wall thickness configured to conduct heat from a flame disposed at the top opening to form a pool of molten candle base material that wets the wicking element at the bottom opening.

5. The self-extinguishing candle of claim 4, wherein the first non-combustible sleeve is comprised of a metal and has a sleeve wall thickness that is at least 0.01 inches.

6. The self-extinguishing candle of claim 5, wherein the metal is selected from a group consisting of copper, aluminum, and steel.

7. The self-extinguishing candle of claim 1, wherein the first non-combustible sleeve is positioned on the wicking element by being crimped onto the wicking element.

8. The self-extinguishing candle of claim 1, wherein the first non-combustible sleeve is crimped onto the wicking element at the top opening of the first non-combustible sleeve.

9. The self-extinguishing candle of claim 1, wherein the gap is at least about ⅛ inches.

10. A self-extinguishing candlewick, comprising:
a single wicking element;
a first non-combustible sleeve that has a top opening and a bottom opening and is disposed on the wicking element so that the wicking element passes through the top opening and the bottom opening; and
a second non-combustible sleeve that has a top opening and a bottom opening and is disposed on the wicking element so that the wicking element passes through the top and bottom openings of the second non-combustible sleeve, the second non-combustible sleeve being disposed below the first non-combustible sleeve and separated from the first non-combustible sleeve by a gap,
wherein the first non-combustible sleeve is configured to conduct heat from a flame disposed at the top opening of the first non-combustible sleeve to form a pool of molten candle base material that wets the wicking element at the bottom opening of the first non-combustible sleeve, and
wherein the second non-combustible sleeve is disposed on the wicking element below the first non-combustible sleeve and is separated from the first non-combustible sleeve by a gap.

11. The self-extinguishing candlewick of claim 10, wherein the distance between the top opening of the first non-combustible sleeve and the top opening of the second non-combustible sleeve is configured so that a candle containing the self-extinguishing wick will burn for a pre-determined time interval and then self-extinguish.

12. The self-extinguishing candlewick of claim 10, wherein the first non-combustible sleeve has a sleeve wall thickness configured to conduct heat from a flame disposed at the top opening to form a pool of molten candle base material that wets the wicking element at the bottom opening.

13. The self-extinguishing candlewick of claim 12, wherein the first non-combustible sleeve is comprised of a metal and has a sleeve wall thickness that is at least 0.01 inches.

14. The self-extinguishing candlewick of claim 13, wherein the metal is selected from a group consisting of copper, aluminum, and steel.

15. The self-extinguishing candlewick of claim 10, wherein the first non-combustible sleeve is positioned on the wicking element by being crimped onto the wicking element.

16. The self-extinguishing candlewick of claim 10, wherein the first non-combustible sleeve is crimped onto the wicking element at the top opening of the first non-combustible sleeve.

17. The self-extinguishing candlewick of claim 10, wherein the gap is at least about ⅛ inches.

18. A self-extinguishing candle, comprising:
a body comprised of a candle base material;
a single wicking element disposed inside the body; and
first and second non-combustible sleeves disposed on the wicking element,
wherein the first and second non-combustible sleeves each have a top opening, a bottom opening, and an inner diameter sized so that the wicking element can wick molten candle base material from the bottom opening to the top opening of the sleeve when a flame is disposed at the top opening of the non-combustible sleeve,
wherein the wicking element passes through the top opening and the bottom opening of the first and second non-combustible sleeves, and
wherein the distance between the top opening of the first non-combustible sleeve and the top opening of the second non-combustible sleeve is configured so that the self-extinguishing candle will burn for a pre-determined time interval and then self-extinguish.

19. The self-extinguishing candle of claim 19, wherein the first non-combustible sleeve is configured to conduct heat from a flame disposed at the top opening to form a pool of molten candle base material that wets the wicking element at the bottom opening.

20. The self-extinguishing candle of claim 19, wherein the first non-combustible sleeve is configured to conduct heat from a flame disposed at the top opening of the first non-combustible sleeve to form a pool of molten candle base material that wets the wicking element at the bottom opening of the first non-combustible sleeve.
